(19) United States
(12) Patent Application Publication
(10) Pub. No.: US 2026/0099543 A1
(43) Pub. Date: Apr. 9, 2026

(54) OBJECT RELATIONSHIP ANALYSIS USING FORCE-DIRECTED GRAPHS BASED ON OBJECT METRIC VALUES

(71) Applicant: SAP SE, Walldorf (DE)

(72) Inventors: Christoph Kommer, Mannheim (DE); Wei-Yi Chen, Mannheim (DE)

(73) Assignee: SAP SE, Walldorf (DE)

(21) Appl. No.: 18/909,950

(22) Filed: Oct. 9, 2024

(51) Int. Cl. G06F 16/901; G06F 16/28

(52) U.S. Cl. CPC G06F 16/9024; G06F 16/288

(57) ABSTRACT

Disclosed techniques provide improved relationship evaluation for computing objects, including to provide improved resource management. First metric values for object instances of a first set of a plurality of object instances of an object type are received. A graph data structure with nodes holding identifiers and metric values is instantiated. Directed edges are generated between nodes using the metric values, and edge weights are assigned based on these values. A graph can be rendered on a user interface, or code can be executed to identify a node pointed to by another node. When the code is executed, the identifier can be used to adjust resource allocation for the identified node, adjust prioritization of processing using the identified node, generate a notification that includes the identifier of the identified node, or trigger a computing process that uses the identifier of the identified node as an argument.

### FIELD

The present disclosure generally relates to analyzing relationships between object instances using force-directed graphs.

### BACKGROUND

Tracking user engagement with electronic content, such as webpages and associated or linked files, email, social media interaction, search queries, chatbot or chat interaction, or event attendance or registration have become very important for many companies, including for providing improved search results or content recommendations. Interactions can be tracked both more granularly and more globally, such as obtaining clickstream data that identifies click patterns on particular content or how users navigate between different pieces of content.

The volume of engagement data can substantial, often involving many terabytes of data. The amount of data requires substantial processing resources, and can limit the type of analyses that can be performed. Accordingly, room for improvement exists.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed techniques provide improved relationship evaluation for computing objects, including to provide improved resource management. First metric values for object instances of a first set of a plurality of object instances of an object type are received. A graph data structure with nodes holding identifiers and metric values is instantiated. Directed edges are generated between nodes using the metric values, and edge weights are assigned based on these values. A graph can be rendered on a user interface, or code can be executed to identify a node pointed to by another node. When the code is executed, the identifier can be used to adjust resource allocation for the identified node, adjust prioritization of processing using the identified node, generate a notification that includes the identifier of the identified node, or trigger a computing process that uses the identifier of the identified node as an argument.

In one aspect, the present disclosure provides a process of generating a force-directed graph. First metric values of a metric type for respective object instances of a first set of a first plurality of object instances of an object type are received. A first instance of a graph data structure having a first plurality of instances of a graph node datatype is instantiated. Respective instances of the first plurality of instances of the graph node datatype hold an identifier and a metric value for a corresponding object instance of the first plurality of object instances.

From the first metric values, including as part of the instantiating, directed edges between pairs of related nodes are generated, and thus related corresponding object instances, using the first metric values of the nodes. For respective pairs of related nodes of the first instance of the graph node datatype, an edge weight is assigned to the edge connecting the nodes in the respective pair. The edge weight is the metric value for a node in the respective pair or a value generated using the metric value for the node in the respective pair.

In one scenario, a graph to be rendered on a user interface that illustrates at least a portion of the nodes and edges of the instance of the graph node datatype, including showing directional relationships between the at least a portion of the node.

In another scenario, code is executed to provide an identified node by identifying a node of the first plurality of nodes pointed to by one or more other nodes of the first plurality of nodes. The process adjusts prioritization of resource allocation to the identified node, generates a notification that includes the identifier of the identified node, generates a notification that includes the identifier of the identified node, or triggers a computing process using the identifier of the identified node as an argument.

The present disclosure also includes computing systems and tangible, non-transitory computer-readable storage media configured to carry out, or includes instructions for carrying out an above-described method. As described herein, a variety of other features and advantages can be incorporated into the technologies as desired.

### BRIEF DESCRIPTION OF THE DRAWINGS

FIGS. 1 and 2 are example web pages that serve as content items from which topic information can be extracted, and user engagement with the content items tracked.

FIG. 3 illustrates code describing keywords identified in content items, as well as topics inferred therefrom, as well as code illustrating how content can include embedded topic information, as well as how topics can be assigned intent scores.

FIG. 4 illustrates code demonstrating how a topic with a particular semantic meaning can be referred to using other terms, and how relationships between topics can be expressed.

FIG. 5 illustrates a computer representation of a topic graph having node metric values corresponding to intent scores and edge weights indicating a strength of a relationship between a pair of related topics.

FIG. 6 provides a visual representation of the graph defined in FIG. 5.

FIG. 7 provides visual representation of the graph defined in FIG. 6, but where edge weights are calculated using intent scores of related nodes and have an imposed directionality, from low intent score nodes to high intent score nodes.

FIG. 8 illustrates how differences between graphs representing two time points can be determined, including for use in identifying upregulated edges or down regulated edges.

FIGS. 9A and 9B provide example code that can be used to implement disclosed techniques.

FIG. 10 illustrates how trending topics can be determined by subtracting intent scores for graph nodes at two time points.

FIG. 11 is a flowchart of a process of generating a force-directed graph.

FIG. 12 is a diagram of an example computing system in which some described embodiments can be implemented.

FIG. 13 is an example cloud computing environment that can be used in conjunction with the technologies described herein.

### DETAILED DESCRIPTION

### Example 1)—Overview

Tracking user engagement with electronic content, such as webpages and associated or linked files, email, social media interaction, search queries, chatbot or chat interaction, or event attendance or registration has become very important for many companies, including for providing improved search results or content recommendations. Interactions can be tracked both more granularly and more globally, such as obtaining clickstream data that identifies click patterns on particular content or how users navigate between different pieces of content.

The volume of engagement data can be substantial, often involving many terabytes of data. The amount of data requires substantial processing resources, and can limit the type of analyses that can be performed. Accordingly, room for improvement exists.

Disclosed techniques can be used to provide a variety of information about various topics that are related to electronic content with which a user engages. Techniques are used to track user interactions with content, relate the content to particular topics or other types of groupings, and then determine “intent” scores for a topic, such as by aggregating intent scores for keywords associated with a topic. Relationships between topics are determined.

Intent scores and topic relationships are used to construct a graph, where nodes of the graph correspond to topics and edges connect related topics. The graph is constructed as a “force-directed graph” by creating an edge from a node with a lower intent score to a higher intent score. In this way, the graph “points” from lower intent score nodes to higher intent score nodes, which can be used, for example, to identify topics that are most relevant to a user at a given time. Edges scores can be assigned that represent a strength of the directional, such as based on the intent scores of nodes in a relationship, as well as an aggregate of all high score intent nodes in the graph. The graph can be a comparatively lightweight structure in some implementations, while higher complexity graphs, such as knowledge graphs, can be used in other implementations.

The force-directed graphs, in some implementations, can be used when visualizing relationships between nodes and edges. This approach uses principles similar to a physical model, where nodes are arranged according to their edge weights, mimicking how physical forces act in a real-world system. Showing directed edges between nodes can help users visualize, for example, how one topic can be linked to other topics that may be of greater interest to users. However, force-directed graphs can also be used without graph visualization, such as when trend analysis is performed, and actions are taken by computing processes.

Information can be extracted from the graph using even more lightweight techniques, such as by generating an asymmetric adjacency matrix that simply tracks relationships between nodes and the edge weights for the particular relationships. In some cases, graphs, or associated adjacency matrices, can be maintained at various times, which can allow intent changes over time to be evaluated. For example, comparing two adjacency matrices can determine which topics are associated with increased intent scores and which topics are associated with decreased intent scores over a particular time period. Thus, information is provided about what topics are “trending” and which topics are seeing decreased user interest.

The described techniques provide technical advantages in that the lightweight nature of the graphs and adjacency matrices require less processing resources to analyze, which can be particularly important when data from different time periods is to be compared. In addition, the graph can be analyzed for additional information, such as identifying nodes or sets of nodes that are the most “relevant”, or to identify topics, or their associated keywords that are popular at a particular time, optionally including information indicating whether the popularity is increasing or decreasing.

In some cases, results of topic analysis can be provided to users in a user interface, such as to guide operational decisions of an enterprise. The results can also be used for automated adjustment of computing processes. For example, user interface features, such as the layout, features, or content of the user interface can be adjusted based on current topic intent data or using trend analysis. The techniques can reduce a computing load by presenting only content, or at least prioritizing content, that is most likely to be relevant to a given user. Thus, the user interface is more efficient for the user, and in terms of computer resource use (such as network, processor, or memory use), by avoiding operations to locate, retrieve, and display content that is less relevant to a user.

In a similar manner, the information from the topic analyses can be used to adjust resources in content delivery networks, or more generally to adjust resources used in delivering content. For example, more resources can be allocated to serving webpages associated with “hotter” user interest. The techniques can allow for systems to preemptively allocate resources before a “spike” in user interest is observed.

Intent information can be used in automated decision systems, such as for manufacturing and supply chains. For example, if interest in a certain product is increasing, an automated decision system can use information about interest spikes to cause more of the product to be produced, or to reduce production if interest is decreasing. Even when such a decision is made manually, information relating to possible demand changes can be provided to users who can choose to cause production to be adjusted.

Interest in topics or content can also be used for security purposes such as security threats or system anomalies. In particular, some topics can be associated with more sensitive information, and so increased activity with respect to such a topic can be used to help determine if behavior is anomalous and may be associated with malicious activity.

Disclosed techniques are fundamentally computer-implemented and are not capable of being performed by a human. For example, automated techniques are used to record information about particular content accessed by users, how long a user interacted with particular content, and user transitions between different content pieces. In addition, graphs and their associated adjacency matrices can be associated with a large number of topic nodes, each of which may be associated with multiple pieces of content, and where intent data is obtained from many users. For example, one-hundred, one-thousand, or higher number of topic nodes may be in a graph, and the underlying data can come from one-hundred, one-thousand, or higher numbers of content pieces, and where user interactions with content are tracked for one-hundred, one-thousand, or higher numbers of users.

Similarly, disclosed techniques provide analyses on a real-time bases, which cannot be performed by a human, particularly when combined with graphs having many nodes and edges, or having data derived from user interactions of multiple users with multiple content items, as described above.

While the present disclosure describes a specific implementation of disclosed innovations related to topic analysis, the techniques can be used with other types of information. More generally, the techniques can be used with instances of an object type, such as topics that are instances of a topic object type. An object type can represent abstract entities, composite datatypes, or more concrete structures depending on the application. For example, object types can include classes in object-oriented programming, structs in lower-level languages, or table definitions in relational databases. A table can be an instance of a more general table class, with individual rows representing instances of a particular object type. Additionally, templates, such as form templates or document templates, can be considered as defining the structure for object instances (such as a key-value format, such as JSON), even though they may not be traditional objects in the programming sense.

These object types define a set of attributes or data members that describe their properties, and individual instances of the object type correspond to these definitions, each having specific values for the defined data members. Instances can represent various entities such as products, users, events, or other conceptual constructs, with attributes like category, timestamp, relevance, or any other relevant data points.

An importance score is a metric that reflects the significance of a particular object instance within its context. A specific example of an importance score is the intent score, but other scores can be used depending on the application-such as relevance, popularity, or frequency. Importance scores can be used to impose directionality on an otherwise undirected graph or for calculating edge weights between nodes. This allows the graph to capture the relationships between object instances more effectively, supporting analysis such as ranking, clustering, or trend detection.

Differences between two graphs can be analyzed. While the graphs can represent, for example, user intent metrics at particular timepoints, graphs were other types of differences can be compared. As an example, it may be useful to compare intent scores for different types of users, such as internal users and external users, or having other user difference, even at the same timepoint.

### Example 2)—Example Extraction of Topics and Intent Scores for Content Items

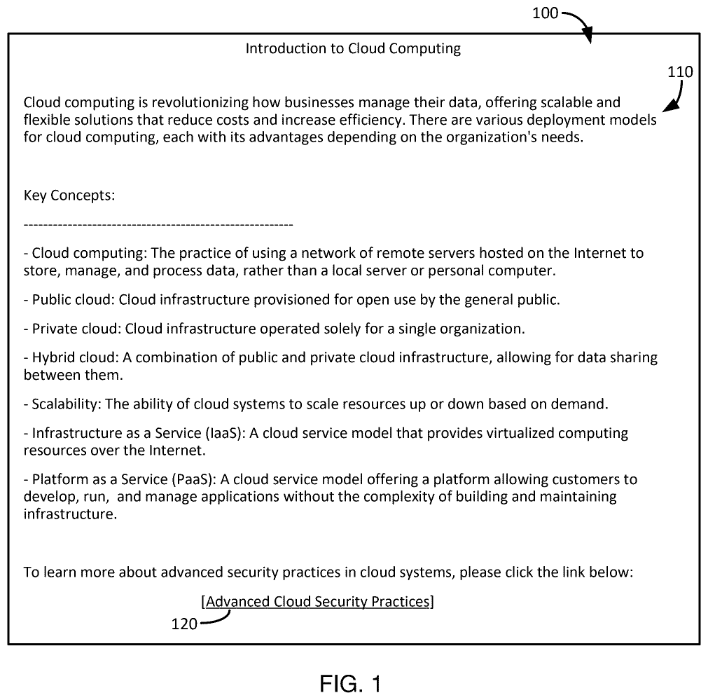

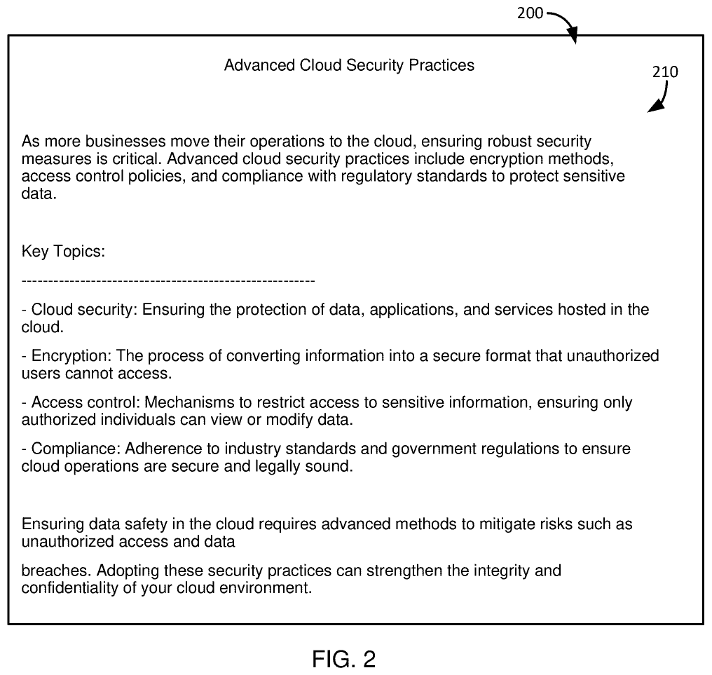

As an example of the processes of disclosed techniques, consider content in the form of the webpage 100 of FIG. 1 and the webpage 200 of FIG. 2. The webpages 100, 200 contain respective text 110, 210. In addition, the webpage 100 includes a link 120 to the webpage 200.

Topics can be determined for content in a variety of ways. In one implementation, topics are determined by analyzing words in the text 110, 210, such as using natural language processing (NLP) techniques. NLP techniques can include tokenization, part-of-speech tagging, and entity extraction, among others. This can be particularly useful when the content of the text is not associated with a more structured context, such as may be provided by a content management system. In another implementation, such as when a more structured context is provided, the content can be directly associated with particular tags. Tags can provide predefined topic categories, and reduce the need for text-based topic inference. A combination of these approaches can also be used.

Assume that the webpage 100 does not contain “embedded” topic tags while the webpage 200 does. For the webpage 100, topics can correspond to particular keywords (which can include one or more words or other tokens, and can be generally referred to as n-grams). An n-gram refers to a sequence of n words, such as bigrams (two words) or trigrams (three words), and can provide more context as compared with only looking at single keywords. Or, topics can be inferred from keywords in the content, and the keywords can be optionally linked to the corresponding topic. For example, the keyword “cloud” and the bigram “cloud computing” can both contribute to an inferred topic of “cloud infrastructure.”

Extracting keywords from the text can be performed using techniques such as Term Frequency-Inverse Document Frequency (TF-IDF) or using word embedding techniques, such as Word2Vec or BERT. TF-IDF provides a statistical measure that reflects how important a word is to a document relative to a corpus, while Word2Vec and BERT generate vector representations that capture semantic relationships between words, or using similar techniques, such as Doc2Vec designed for analyzing longer text sections, including those that may include multiple n-grams. Some topics may be “latent” in the document text, which can include topics that are not represented by a keyword, or topics that subsume multiple keywords. These topics can be identified using techniques such as Latent Dirichlet Allocation or Non-Negative Matrix Factorization (NMF). LDA is a probabilistic model that discovers abstract topics based on patterns of co-occurring words, while NMF decomposes a document-term matrix to find topics and their associated keywords. Named Entity Recognition (NER) techniques can be used to extract named entities from the text.

In addition to using embedding techniques like Word2Vec or BERT, Large Language Models (LLMs) (or more generally, neural language models) can be leveraged to enhance the contextual understanding of topics, keywords, and product descriptions. LLM-based embeddings capture nuanced language patterns, facilitating the identification of deeper relationships between keywords and broader product descriptions. These models can be used to create contextual topic clusters, build hierarchies, or develop taxonomies that group related topics together. For example, embeddings derived from LLMs can relate product-specific keywords such as “Cloud Infrastructure” or “PaaS” to larger product categories like “Cloud Solutions,” allowing for more improved organization and analysis of content.

Intent scores can be used to measure the significance of user interaction with particular content, including particular topics or keywords in the content. For instance, if users frequently interact with a specific keyword or topic on the page, this may suggest a high level of engagement and thus a higher intent score. Intent can be measured using certain “triggers,” which can also correspond to intent metrics. Examples of intent metrics include page views, the time spent on a page, user interaction with user interface elements such as links or buttons, downloads, views of a video, including how long a video was watched, user queries to find content, or social media activity, such as sharing content, “liking” content, or reviewing content. User queries, such as searches within a page or site, can provide direct evidence of the user's focus on a particular topic, leading to higher intent scores for that topic.

Additionally, intent can be modeled using techniques such as machine learning (ML) models or anomaly detection. For example, ML models can be trained to predict intent scores based on patterns of user behavior that correlate with specific outcomes, such as purchasing decisions, content downloads, or positive customer sentiment. A model can detect, for instance, that a certain frequency of visits to research-oriented content correlates strongly with later purchases or inquiries about related products, allowing for intent scores to be more accurately targeted toward key organizational goals.

Additionally, embeddings derived from Large Language Models (LLMs) can be used not only to enhance topic inference, but also to identify clusters, hierarchies, and taxonomies among topics and their relationships. These embeddings provide more complex, contextual representations of topics and keywords, allowing for better organization of content related to products or services. For example, when comparing product descriptions or customer interaction data, LLM-based embeddings can identify similarities that might otherwise remain undetected. By applying these models, organizations can group related terms and establish contextual topic clusters, facilitating more accurate content targeting and recommendation strategies. This allows the creation of product hierarchies, where lower-level topics (e.g., “Platform as a Service”) are aggregated into higher-level categories (e.g., “Cloud Solutions”), thereby supporting more comprehensive content structuring.

Anomaly detection techniques can be used to identify unusual patterns in user behavior that may indicate heightened intent. For example, if a user typically spends a minimal amount of time on a product page but suddenly increases their engagement significantly, this spike in activity can trigger a higher intent score. Anomaly detection can be particularly valuable in cases where user behavior significantly deviates from typical interaction patterns. Such deviations can flag emerging interest or intent that may not be captured by standard metrics.

Various indicators of “intent” can be ranked and combined to provide an intent score, such as where indicators that are more indicative of strong intent are weighted more heavily. For example, the act of downloading a document might indicate a higher intent than simply viewing the webpage. Page views may be weighted less than download activity, while time spent watching a video can be given a variable weight depending on how long a user watched the video. Machine learning models can also be trained to refine the weighting system, learning over time which user actions correlate most strongly with meaningful intent.

In some implementations, intent scores can be further refined by correlating user activity with specific outcomes, such as successful sales or positive sentiment expressed through customer feedback. For example, a model can learn that users who visit product comparison pages frequently and then return to product detail pages are more likely to complete a purchase. By associating intent metrics with these end results, organizations can more effectively prioritize their content or marketing strategies based on data-driven insights. Similarly, intent can be tied to sentiment analysis, where user interactions with content that receive positive feedback or reviews can be weighted more heavily, indicating a higher likelihood user satisfaction or conversion.

A variety of tools exist for such tracking, including GOOGLE ANALYTICS or automation tools such as HUBSPOT or MARKETO. These tools can also generate intent scores. In another implementation, user interactions are used to train a machine learning model, which can then assign an intent score given an input set of interaction data. The machine learning model can be optimized based on user behavior patterns, identifying which actions are the best predictors of future engagement or conversion.

User interactions can be tracked on a per-user basis, as well as tracking interactions across users. Similarly, intent scores can be calculated for particular topics (including by aggregating interactions with various keywords that are associated with a particular topic) by aggregating intent scores for multiple pieces of content that relate to a particular topic, both in terms of a “session” for any single user or multiple sessions by multiple users. For instance, if multiple users show high intent scores for “Cloud Computing” across different sessions, this can signal a broader trend of interest in that topic.

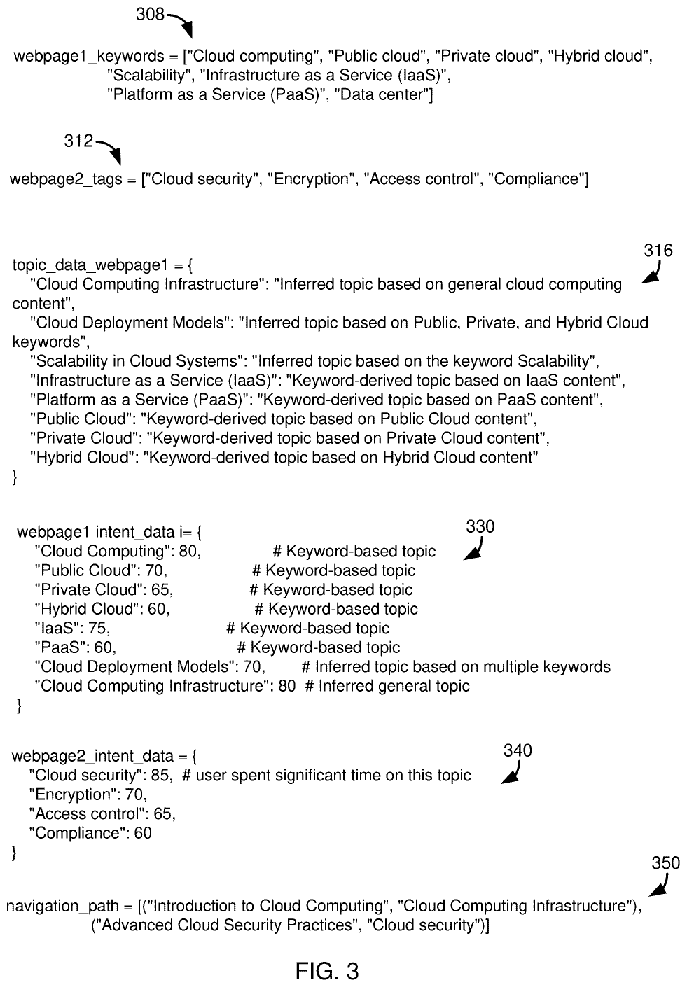

FIG. 3 illustrates various types of data that are associated with the webpages 100 and 200, and associated user interactions. A vector 308 provides keywords extracted from the webpage 100, while a vector 312 provides tags assigned to the webpage 200. A dictionary 316 provides topics inferred from the keywords, including their interrelationships, and their relationships with inferred topics. These relationships may be represented in a graph, where nodes correspond to topics and edges represent connections or co-occurrences between topics. In many cases, the “type” of topic may not be relevant to subsequent analysis, and the type information can be omitted, in which case the topics in the dictionary 316 can instead be represented as a vector. For example, a simple vector of topic names could be used if information about the “origin” of topics is not needed for a specific analysis.

Dictionaries 330 and 340 provide intent data for webpage 100 and webpage 200, respectively. Each topic identified for a given webpage is assigned an intent score, such as described above. Note that even though the topics in the dictionaries 330, 340 are from the same content, they have different intent scores. This can occur because intent scores may be influenced by both the user's behavior (e.g., interactions with specific parts of the content) and the content's structure or layout (e.g., topic prominence or frequency of occurrence). This can arise for various reasons, including cases where intent scores are based on the content or structure of the content, and not just user interaction with the content, or where user interactions with the content can be tracked on a more granular basis.

As an example of more granular user interaction data, different parts of a document can be associated with a different scroll depth, and the time spent at a particular scroll depth can be weighted more heavily than for topics associated with a different scroll depth. For example, if a user spends more time at a particular section of a page discussing “Public Cloud,” this section and its associated topic may receive a higher intent score. Clickstream analysis can also be used if there are particular user interface elements with which a user interacts that are more “proximate” a particular topic. Clickstream data helps identify which parts of a webpage users engage with more actively, providing finer-grained insight into topic-level engagement.

FIG. 3 also includes path information 350 for a particular navigation path observed from user interactions with content items. The path can be between topics in a single content item, or between content items. A particular navigation path can have a metric indicating how frequently the path occurs, and individual steps within the path can have a metric indicating how common that navigation action is. This information can be used to establish, and quantify, relationships between topics.

Keywords or phrases can be analyzed for their frequency within the content, and topics associated with frequently occurring keywords can be weighted more heavily. Similarly, the same topic can be identified in content multiple times (such as based on different keywords or keywords appearing in different sections of the content), and this can be used to adjust intent scores accordingly. Section information can also be used to weight information, such as if text in a webpage that is associated with particular keywords is emphasized in some manner or used in more prominent sections, like in a page heading or subheading. If a user searches for a specific term, its associated topic can be weighted more heavily than terms that simply appear in the content. In cases where a keyword or topic is repeatedly mentioned across different sections, its relevance may be rated higher, leading to an increased intent score for that topic.

Determining relationships between topics from different content sources, especially when the topics are not explicitly tagged, can be performed using a variety of techniques. Synonym detection is applied to identify when different keywords or n-grams refer to the same or semantically similar topics. This can be particularly useful when the content does not rely on structured topic tags, and instead, the topics are inferred from the text.

Synonym and relatedness relationships can be detected using semantic embedding models, such as Word2Vec, GloVe, or BERT. These models generate vector representations for words, phrases, or entire topics, allowing for comparison of both synonymy (when terms refer to the same topic) and relatedness (when terms refer to different but closely related topics). Cosine similarity or other distance metrics can be used to compare these embeddings, with higher similarity scores indicating stronger relationships between the topics, whether they are synonymous or closely related. Additionally, by leveraging neural language model-derived embeddings, contextual hierarchies can be generated, where related terms can form clusters or more abstract categories, contributing to a richer taxonomy. For example, “Infrastructure as a Service” and “Public Cloud” may cluster together under a broader category such as “Cloud Services,” which helps establish how specific topics fit within larger product narratives or schemas.

For example, consider the terms “Cloud Computing” and “Cloud-Based Computing.” The two terms are essentially synonyms, both referring to the same topic: the use of remote servers to store, manage, and process data. Semantic analysis using embeddings can detect that these terms have very similar embeddings, indicating that they refer to the same underlying concept.

On the other hand, consider the topics “Cloud Computing” and “Cloud Infrastructure.” While these topics are distinct, semantic analysis may determine that they are closely related based on a similarity score for their embeddings. “Cloud Computing” broadly refers to the practice of using remote servers for computing tasks, while “Cloud Infrastructure” refers to the physical and virtual components that support cloud computing. Although the terms differ in focus, their semantic embeddings may show a high degree of similarity, indicating that they belong to related areas within the same overarching field, thereby establishing a relationship between the two topics.

Named Entity Recognition (NER) can also be used for identifying relationships between topics, particularly when the topics involve specific entities, such as product names, organizations, or locations. For example, content about a specific cloud platform (e.g., “AWS” or “Amazon Web Services”) may appear under different names in different documents. Using NER, these named entities can be extracted and linked to a common topic across the content, even when they are referred to using different terms.

When a large number of topics are derived from different sources, techniques such as Latent Dirichlet Allocation (LDA) or Non-Negative Matrix Factorization (NMF) can be applied to discover latent topics across content items. These techniques cluster related keywords into broader topics even when the individual terms differ. For instance, LDA applied to content from webpage 100 and webpage 200 may determine that “Public Cloud” and “Private Cloud” are subtopics of a larger inferred topic such as “Cloud Architecture.” This harmonization allows for a unified understanding of content across sources.

Synonym detection algorithms may use predefined taxonomies or ontologies to specify known relationships between terms. For example, a taxonomy might define that “PaaS” and “Cloud Platform” are synonymous, allowing content about “PaaS” to be linked to “Cloud Platform” across different documents. These relationships can be expanded with machine learning models that learn new synonym relationships over time based on user interaction data.

If there is no predefined taxonomy, contextual similarity across content items can be used to infer topic relationships. For example, keywords that frequently co-occur in similar contexts (e.g., in discussions of cloud services) may be inferred to be related. Co-occurrence analysis, which constructs matrices showing how often terms appear together, can identify relationships between topics otherwise expressed using different terms. Semantic embeddings can further enrich this process by detecting latent similarities.

Once relationships between topics are inferred using techniques such as synonym detection, co-occurrence analysis, and semantic embeddings, these relationships can be further enriched through the creation of contextual clusters and hierarchies. For example, topics like “Cloud Infrastructure” and “PaaS” can be grouped into higher-level clusters such as “Cloud Solutions,” facilitating a more structured representation of product knowledge. This hierarchical organization allows for dynamic analysis, where nodes can be grouped by relevance or relationship to products, providing insights into user behavior patterns and enhancing tailored content delivery strategies.

Neural language model-based embeddings further enhance the creation of these contextual clusters and hierarchies by capturing deeper semantic insights. These embeddings allow for more accurate grouping of related topics, even when the relationships are more abstract or implicit, providing organizations with the ability to detect novel relationships or emerging trends in user interactions. By leveraging the subtle language patterns captured by embeddings, more precise content targeting can be achieved, and a more detailed analysis of how topics evolve and interact within a broader context.

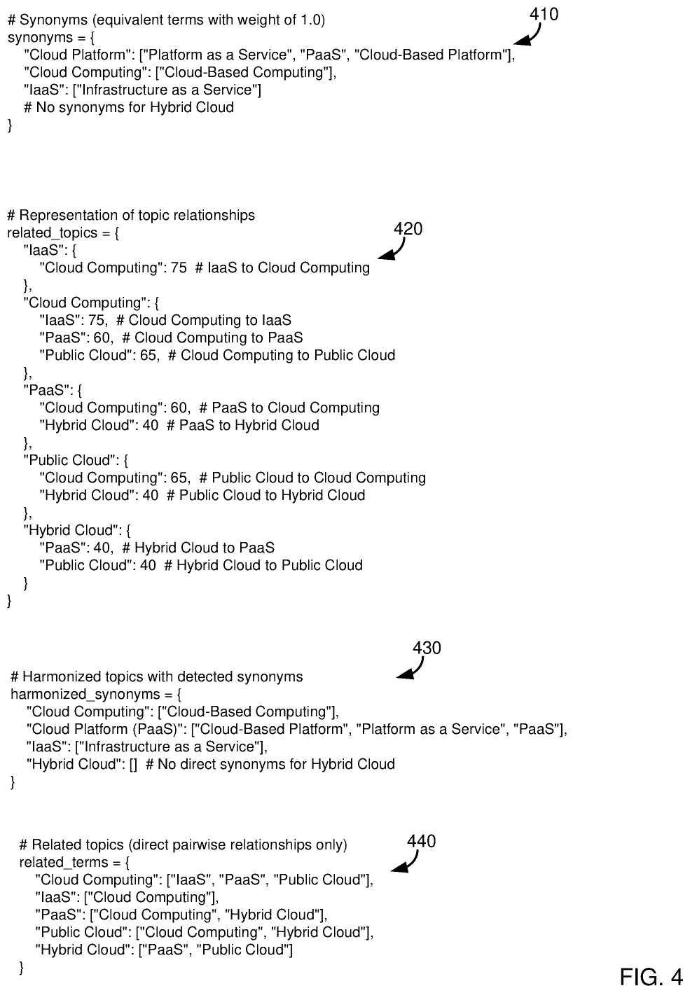

FIG. 4 presents examples of computing structures that can be used to determine and store synonym information. In particular, code 410 provides a representation of synonyms in a graph, in this case providing a particular topic and, in braces, topics that are determined to be synonyms. As shown, all synonyms have a similarity score of 1. However, lower thresholds can be defined, where topics that satisfy the threshold are determined to be synonyms and topics that do not satisfy the threshold are determined to be related, but not synonyms. Code 420 provides a representation of topics that are related to a given topic, where each topic is shown with its related topics in braces, along with a score representing semantic similarity between the topics.

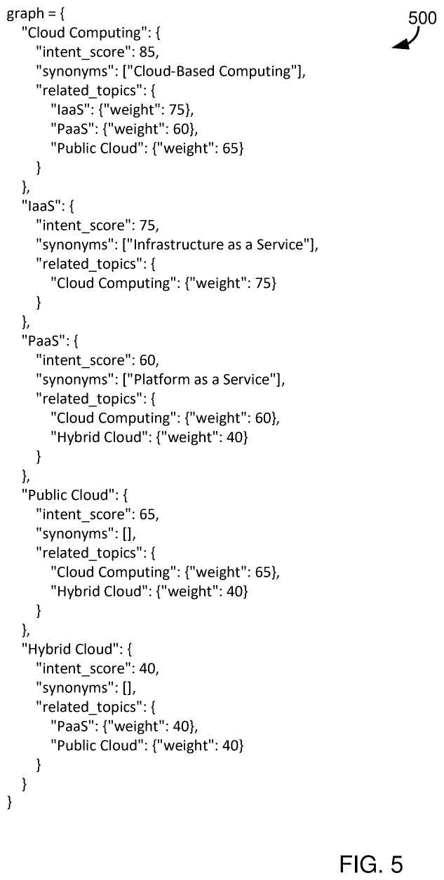

From the synonym information in the code 410, code 430 provides a list of harmonized topics. Code 430 can be used when aggregating intent scores from different content items to ensure that synonymous topics are treated as a single entity. From the relationship information in code 420, code 440 provides a dictionary of related topics, which can be used to define edges between topics in the graph structure. FIG. 5 shows code 500, which defines the topic graph representation in a dictionary structure, including intent scores for each topic, synonyms of the topics, direct relationships to other topics, and scores indicating the strength of those relationships.

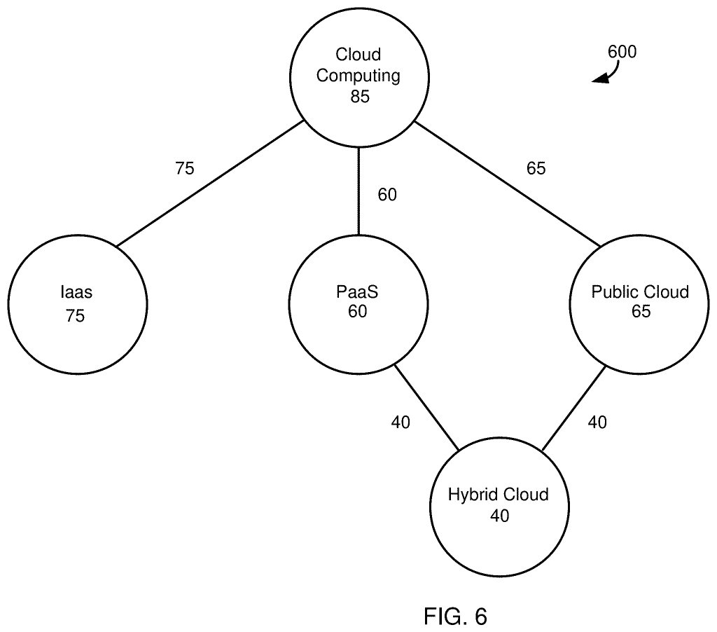

The topic graph can also be represented as an adjacency matrix, where the inferred relationships between topics are captured as weighted values based on similarity scores or co-occurrence frequencies. This structure is particularly useful for discovering clusters of related topics through community detection algorithms, enabling the identification of broader trends and interests across the content corpus. An example adjacency matrix is provided below, where rows and columns both run from T1 to T5, where the assignment of T values to topic nodes is shown in FIG. 6 as a graphical representation 600 of the topic graph 500, with the assumption that the edges are undirected.

| | | | | |
|---|---|---|---|---|
| 0 | 75 | 0 | 0 | 0 |
| 75 | 0 | 60 | 65 | 0 |
| 0 | 60 | 0 | 0 | 40 |
| 0 | 65 | 0 | 0 | 40 |
| 0 | 0 | 40 | 40 | 0 |

In some scenarios, such as when various topics are relevant to a product of a particular organization, it can be useful to associate content topics with specific products to provide contextually relevant information to users, especially in environments where multiple products are discussed across various pieces of content. For example, consider a scenario where a webpage is primarily focused on “Cloud Computing Infrastructure.” A company offering multiple cloud solutions, such as CloudMax Compute, CloudMax PaaS, and SecureCloud, may want to ensure that content is properly mapped to the relevant product. In this case, “CloudMax Compute” might be associated with topics like “IaaS” and “Public Cloud,” while “CloudMax PaaS” could be more closely associated with topics such as “PaaS” and “Application Hosting Platforms.” As will be further described, correlating topics to products can be useful, including because increased or decreased interest in a topic may correspond to increased or decreased interest in a product associated with that topic.

Content association with products can be performed in various ways, depending on the structure of the content. For webpages containing structured metadata, product associations may be directly encoded within the page through tags or metadata fields, such as data-product=“CloudMax Compute”. This tagging directly maps the topic to the relevant product without relying on inference techniques. For example, a page describing the technical specifications of “CloudMax Compute” might include tags such as IaaS, Cloud Computing, and Virtual Machines, while a product page for “CloudMax PaaS” might use tags like PaaS, Application Deployment, and Microservices.

When product associations are not explicitly provided, techniques similar to topic inference can be used to establish a relationship between the content and the relevant products. By analyzing the keywords and latent topics within the content, products can be linked to content based on the strength of the association between the product and the identified topics. For example, if the content frequently mentions terms such as “infrastructure,” “virtual machines,” and “scalability,” it might be inferred that the content is discussing “CloudMax Compute.” Similarly, repeated mentions of “platforms,” “deployment,” and “application scaling” can indicate that the content relates to “CloudMax PaaS.”

Associating products with topics can use of semantic embeddings and similarity models. Both product descriptions and content are embedded into a high-dimensional space where similarity between products and topics can be measured directly. For instance, product descriptions for “SecureCloud,” which focuses on encrypted data storage and secure transmission, may be embedded in such a way that they closely align with topics such as “Data Encryption” and “Security Protocols.” This embedding-based association allows for more flexible and dynamic linking of products to topics, even in cases where the exact terminology used in the content does not explicitly match the product's description.

Additionally, embeddings derived from neural language models or other advanced models can be leveraged to construct contextual hierarchies that relate more granular topics or keywords to larger product categories. This allows for the development of taxonomies where specific product-related terms (e.g., “infrastructure” or “scalability”) are connected to broader product descriptions, such as “CloudMax Compute” or “Cloud Solutions.” These techniques can be used to generate a dynamic, layered understanding of how keywords and topics align with both product attributes and higher-level product groupings, which can improve the precision of content organization and recommendation strategies.

In addition to clustering, Hidden Markov Models (HMMs) can be used to model transitions between topics, where the probability of moving from one topic to another is represented by the edge weights. HMMs are particularly valuable for extracting meta-information via latent state variables from the graph, allowing organizations to infer hidden patterns or behaviors in user interactions. For example, the latent states in an HMM can represent unobserved user intents or preferences that influence their navigation choices between topics. This technique offers a way to capture underlying structures or behaviors that are not directly observable from the raw data. By tracking the transitions between latent states, HMMs can elucidate how users traverse related topics or content and predict future interactions.

Incorporating Hidden Markov Models (HMMs) can further enhance the analysis of product-to-topic associations by capturing hidden or latent relationships between products and topics. These latent state variables represent meta-information that reveals deeper connections between user interactions with specific products and underlying user intents or interests. For example, in cases where direct associations between content and products are not explicitly tagged or easily identifiable, HMMs can infer hidden states that reflect a user's evolving interest in a product category, such as moving from “PaaS” to “Cloud Infrastructure” as the latent states change. This can provide organizations with a more comprehensive understanding of how users engage with products across different content items, even when these associations are not overt.

Markov chains, stochastic models, and other techniques such as embedding-based similarity analysis are also valuable for analyzing user engagement and inferring product-topic relationships in a dynamic, evolving content landscape. Other stochastic models, such as Markov chains or random walks, can also be used to predict user behavior and track how users interact with content over time. By applying these models, organizations can better understand user journeys and optimize pathways through content clusters.

Other stochastic models, such as Markov chains or random walks, can also be used to predict user behavior and track how users interact with content over time. By applying these models, organizations can better understand user journeys and optimize pathways through content clusters. Edge weights can further support trend analysis by showing how user interest shifts over time. A strong relationship between “IaaS” and “PaaS” may indicate that users frequently transition from infrastructure services to platform services, allowing organizations to better anticipate user needs and adjust their offerings. By applying Markov chains in this context, it is possible to track and predict how users might shift between topics over time, offering insights into emerging trends or shifts in user interest.

Edge weights can also be used for influence analysis, showing how user intent evolves over time. A strong relationship between “IaaS” and “PaaS” may indicate that users frequently transition from infrastructure services to platform services, providing businesses with valuable insights to anticipate user needs and adjust their offerings. A user journey refers to the sequence of steps or interactions a user takes while navigating through topics or content. Often, these journeys are engineered to guide users along specific pathways, encouraging them to explore particular topics or services in line with business goals. By understanding and optimizing these journeys, businesses can design more effective pathways to lead users through relevant content or offerings. Markov chains and other stochastic models can help map these journeys, identifying the most likely transitions and interactions between topics.

It can be useful to analyze topic graphs by different “segments,” which can be categories that restrict a topic graph to a subset of available intent data. For example, categories can be defined based on specific user groups, organizations, or other demographic characteristics, especially when different users interact with the content in distinct ways.

One approach is to maintain a single graph structure that includes all segments, such as users for whom data is available, while storing additional metadata for each interaction. This metadata can include attributes such as user organization, geographical region, or user type (e.g., enterprise vs. small business). Intent scores for each topic can be calculated separately for each segment, allowing for both segmented and combined analysis without creating multiple graphs. For example, an organization might calculate distinct intent scores for topics such as “CloudMax PaaS” for Organization A and Organization B, using the metadata to provide for a segmented analysis.

Another approach is to create separate graphs for each segment. In this approach, each segment has its own independent graph, where nodes represent the same topics, but the edges and weights vary according to the segment-specific interactions. For example, Organization A might show a stronger relationship between “Cloud Computing” and “IaaS,” while Organization B demonstrates stronger engagement between “PaaS” and “Application Hosting Platforms.” The use of multiple graphs can allow for highly focused analysis but can require more computational resources as the number of segments increases.

Hierarchical graphs can be used to organize topics and segments in layers. In a hierarchical graph, a parent node can represent an overarching topic (e.g., “Cloud Solutions”), while child nodes represent specific subtopics or variations by segment (e.g., “CloudMax PaaS” for Organization A vs. “CloudMax Compute” for Organization B). This hierarchical organization allows for analysis at different levels of abstraction. Users can analyze the relationships and intent scores for broad topics or drill down into specific segment-based subtopics. Hierarchical graphs are particularly useful when there is a need to represent multiple levels of granularity or when handling overlapping segments.

Hierarchical graphs can be used to organize topics and segments in layers. In a hierarchical graph, a parent node can represent an overarching topic (e.g., “Cloud Solutions”), while child nodes represent specific subtopics or variations by segment (e.g., “CloudMax PaaS” for Organization A vs. “CloudMax Compute” for Organization B). This hierarchical organization allows for analysis at different levels of abstraction. Users can analyze the relationships and intent scores for broad topics or drill down into specific segment-based subtopics. Hierarchical graphs are particularly useful when there is a need to represent multiple levels of granularity or when handling overlapping segments.

A dynamic graph approach can also be used, where metadata (such as organization or user type) is embedded directly into the nodes and edges. This enables on-demand filtering of the graph, allowing segments to be isolated or analyzed dynamically without storing separate graphs for each segment. For instance, a dynamic query can extract all interactions related to enterprise users engaging with “CloudMax Compute,” while excluding interactions from small businesses. This approach reduces overhead and allows for real-time segmentation and customization without creating new graph structures.

In cases where multiple segmentation layers (e.g., organization and geography) are to be used, a combination of approaches can be used. Graph partitioning algorithms can be used to divide the graph into sub-graphs, allowing for more efficient segmentation analysis when many units of segmentation are involved. This technique helps balance computational complexity and helps analyses scale without becoming overloaded, even when multiple layers of segmentation are present.

When using metadata tagging or predefined taxonomies, additional layers of segmentation may be stored directly within the graph structure itself. For example, edges between topics can carry metadata about which user group, organization, or geographical region was involved in creating a relationship between topics. This approach allows for rich, segmented analyses that can be sliced and filtered based on these additional dimensions. In cases where user behavior differs significantly across groups, it allows the same graph structure to be used while performing distinct segment-based calculations on edge weights or node importance.

### Example 3—Example Force Directed Graph and Associated Edge Weight Values

Disclosed techniques can use a topic graph that differs from the graph 600 of FIG. 6. That is, in the graph 600, the edges were undirected, and the edge weights corresponded to the strength of a relationship between a pair of given topics. A force-directed graph can be constructed such that edges are directional, pointing from a node having a lower intent score to a node having a higher intent score. The edges can be assigned a weight using an aggregation measure. The graph can reflect that users are more likely to select higher score topics than lower score topics, and that co-occurrence of keywords is correlated with a “push” toward higher scoring keywords.

In determining edge weights for the graph, node pairs can be analyzed to determine which node in each pair has the higher intent score and which has the lower intent score. The force-directed graph is constructed by having edges directed from the node with the lower intent score to the node with the higher intent score, reflecting the flow from less influential topics to more influential topics.

Edge weights can be assigned using the following calculation:

$$Edge Weight = \frac{high intent score}{low intent score} \times \frac{high intent score}{Maximum Possible Intent Score}$$

In this equation, the high intent score is the score for the node with the higher score in a pairwise node relationship, while the low intent score is the score for the node with the lower score in the relationship. The second term in the equation serves to normalize the calculated edge weights, in this case using the maximum possible intent score. For example, if intent scores are provided in a range of 0-100, the maximum possible intent score is 100. This results in edge weights that emphasize the relationships between individual pairs of nodes, with higher intent nodes exerting more influence.

Other approaches to edge weighting can also be used, including not normalizing the weights at all or normalizing them by the sum of all intent scores, not just those for high intent nodes. If edge weights are not normalized, the raw ratio of the high intent score to the low intent score is used, simplifying the calculation. One reason to omit normalization can be in situations where the intent values are already normalized, such as when intent scores are pre-scaled based on maximum observed or expected values. In such cases, the pre-normalization makes additional normalization redundant and can simplify the computation further. This approach can be useful in cases where localized relationships between specific node pairs are of primary interest, and the impact of the broader graph structure is of lower importance.

As an alternative approach, edge weights can be calculated using the following equation:

$$Edge Weight = \frac{high intent score}{low intent score} \times \frac{high intent scores total}{Maximum Possible Intent Score}$$

In this alternative method, the edge weights are normalized using the sum of high intent scores for all nodes that are the higher intent node in at least one relationship. In this equation, 100 represents the maximum possible intent score. In other implementations, the maximum observed intent score can be used in place of 100. This method provides a broader normalization, accounting for the influence of all high-intent nodes across the graph, stabilizing edge weights so that no single high-intent node exerts disproportionate influence.

However, this approach is computationally more intensive compared to methods that do not normalize or that use pre-normalized values, as the sum of all high-intent scores must be computed. When prenormalized intent values are not used, this approach may result in certain high intent nodes dominating the graph, potentially overshadowing meaningful relationships involving lower intent nodes. On the other hand, normalizing edge weights by the sum of all intent scores (both high and low) provides a more balanced view by accounting for the overall distribution of intent scores. By considering the entire distribution, this broader normalization technique highlights trends involving both high and low intent nodes, providing a more comprehensive view of the graph. However, this method may also dilute the influence of high-intent nodes, potentially underrepresenting their significance in the overall structure.

While any of these approaches can be used, the interpretability of these changes may vary depending on the approach used. Without normalization, edge weights are based solely on the ratio of high intent score to low intent score, which means that any changes in individual intent scores will directly affect edge weights over time. This can be particularly true when intent scores are already normalized, as further normalization may not be necessary to achieve a balanced graph structure. If the difference between the node scores changes significantly, a corresponding shift in edge weights will be observed. This approach is useful for analyzing changes in specific node pairs over time but is less useful for detecting global trends since it lacks a scaling factor to account for broader changes in the graph's structure.

When normalizing edge weights by the sum of all node scores, the entire graph's score distribution is considered. This approach smooths out fluctuations in individual node relationships and provides a more balanced view of how both local and global relationships evolve over time. This normalization makes it easier to detect systemic changes in the graph's structure, as any global shifts in intent scores will be reflected in the edge weights.

Normalizing edge weights using only the high intent scores offers a more focused analysis of changes involving the most significant nodes. This approach helps show the evolution of relationships where high-scoring nodes are central, allowing for more detailed insights into how the flow from low to high intent nodes changes over time. By excluding low-scoring nodes from the normalization, shifts in high-scoring nodes have a greater impact on edge weights, highlighting the most influential nodes and their evolving role in the graph. This approach focuses on the most important relationships, though it may de-emphasize the role of less influential nodes.

In contrast, the alternative method of normalizing edge weights by the sum of high intent scores offers a more global perspective on the graph structure. It smooths out fluctuations in individual node relationships and provides a more balanced view of how both local and global relationships evolve over time. This normalization makes it easier to detect systemic changes in the graph's structure, as any global shifts in intent scores will be reflected in the edge weights. However, it may de-emphasize localized relationships in favor of a broader, systemic view.

Additional or alternative weighting techniques can be used. For example, the number of relationships in which a particular node serves as the high intent node can be used as a weighting factor. This weighting factor takes into account not only the raw intent scores of the nodes but also how frequently they serve as a higher-scoring node in pairwise relationships. For instance, if Node A has a high intent score but appears as the higher-scoring node in only a few relationships, while Node B has a slightly lower score but consistently serves as the higher-scoring node in many connections, weighting Node B more heavily can highlight its greater influence in the graph.

As another approach, normalization, such as using one of the techniques described above, can be based on the total number of relationships in the graph, rather than using a fixed value like 100. This technique provides consistency as the graph changes over time, allowing for comparisons across different versions of the graph while accounting for its size and complexity. Normalizing by the number of relationships helps ensure that edge weights remain stable and proportional to the actual structure of the graph, preventing disproportionate influence from a growing number of connections.

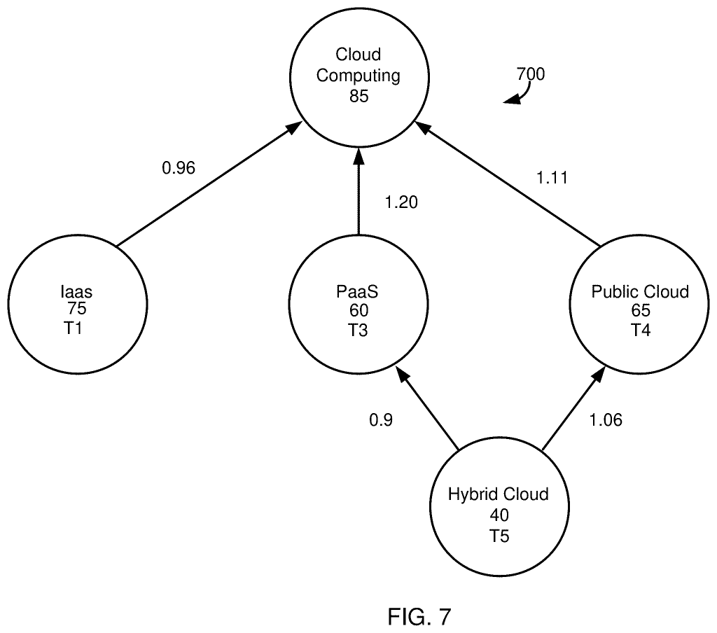

FIG. 7 provides a force-directed graph 700 that can be generated from the graph 600 of FIG. 6. The individual edge weights can then be calculated according to the equation provided earlier. For each node pair, the edge weight is determined by dividing the high intent score by the low intent score and multiplying by the normalization factor, which is the high intent score in the pair divided by 100.

For example, considering the relationship between the IaaS node and the Cloud Computing node, the edge weight is calculated as (85/75)×(85/100), or approximately 0.96. The other edge weights can be calculated in the same manner and are shown in the graph 700. Note that, as expected from the nature of the equation, edge weights are primarily affected by the difference between the high intent score and the low intent score in each pairwise relationship, while the normalization helps appropriate scale the influence of the high intent score is appropriately scaled.

Information in the graph 700 can be represented in an adjacency matrix, which can facilitate computations, such as determining differences between graphs generated from data at different points in time. Assume that the topics in the graph 700 are assigned the topic numbers shown in FIG. 7. That is, IaaS is T1, Cloud Computing is T2, PaaS is T3, Public Cloud is T4, and Hybrid Cloud is T5. The adjacency matrix is then formed as shown below.

$$[ \begin{matrix}0 & 0.96 & 0 & 0 & 0 \\ 0 & 0 & 0 & 0 & 0 \\ 0 & 1.2 & 0 & 0 & 0 \\ 0 & 1.11 & 0 & 0 & 0 \\ 0 & 0 & 0.9 & 1.06 & 0\end{matrix} ]$$

Graph-based analyses such as PageRank and Markov chains can be adapted to the force-directed graph with intent-score edge weights. In this context, PageRank calculations will prioritize nodes with higher intent scores that receive many directed edges from lower intent nodes. This approach highlights the flow of influence from less important to more important topics, emphasizing nodes that are central in terms of user intent and engagement. The directional nature of the edges ensures that the PageRank score reflects the hierarchical structure of user interests, with higher intent nodes being more influential.

Markov chain analysis can also be applied to the force-directed graph, where transition probabilities are influenced by the directionality and the ratio of intent scores. Transitions are likely to flow from nodes with lower intent scores to those with higher intent scores, modeling user behavior based on intent-driven pathways. This approach helps predict how users might progress from less influential to more influential topics over time, providing insights into user journeys and content navigation patterns.

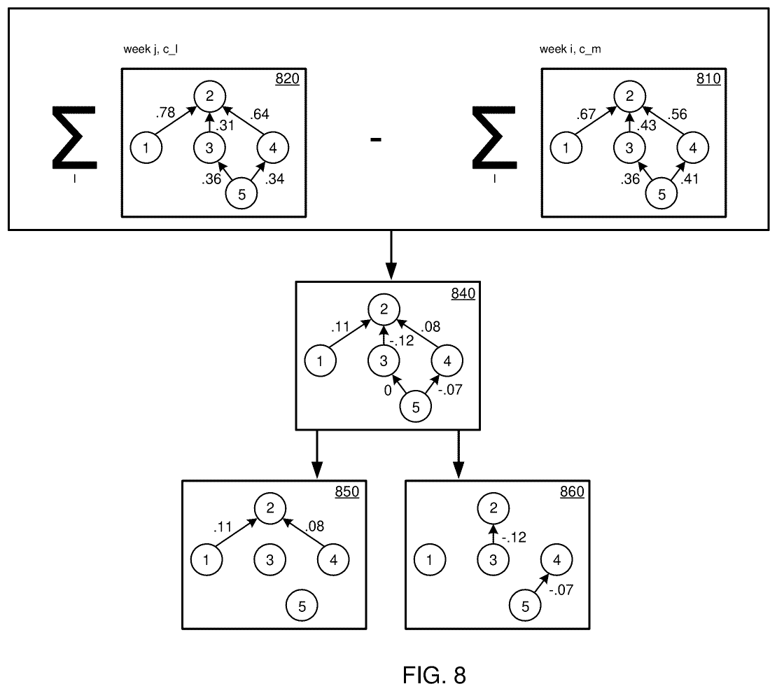

Two differential analyses can be performed using graph information at two time points. In a first approach, illustrated in FIG. 8, a difference graph 840 is obtained by subtracting graph information, such as edge weights for a graph 810, at a first point in time from graph information from a graph 820 at a second point in time, such as where the second point of time is a later point in time. The summation notation for the graphs 810, 820 indicates that the summation can be a summation over multiple segments, such as data for multiple customers. For example, assuming data was obtained for three customers, the summation can be carried out on the edge weights for each customer (that is the summation is carried out over customer 1 to customer 3). Other aggregation measure can be used in place of the summation, such as using the mean or median of data for the three customers.

The difference graph 840 includes information for both “upregulated” edges, having a positive change in edge weight over the time period, and “downregulated” edges, having a negative change in edge weight. The difference graph 840 can be displayed showing both types of edges, including showing upregulated edges in a different visual style (such as color, linewidth, use of dashed or solid lines) than that used for downregulated edges.

Alternatively, information in the difference graph 840 can be used to provide a graph 850 that only shows upregulated edges or a graph 860 that shows only downregulated edges.

Representing graph information in an adjacency matrix can facilitate the calculation of the edge weights for the difference graph 840, as well as calculations for the graph 850 and 860. Adjacency matrices provide a compact and efficient way to store and manipulate graph data, especially for dense graphs where most nodes are interconnected. Many computing languages have computing libraries that have highly optimized functions for performing matrix operations, such as addition, subtraction, and multiplication, including parallelizing operations.

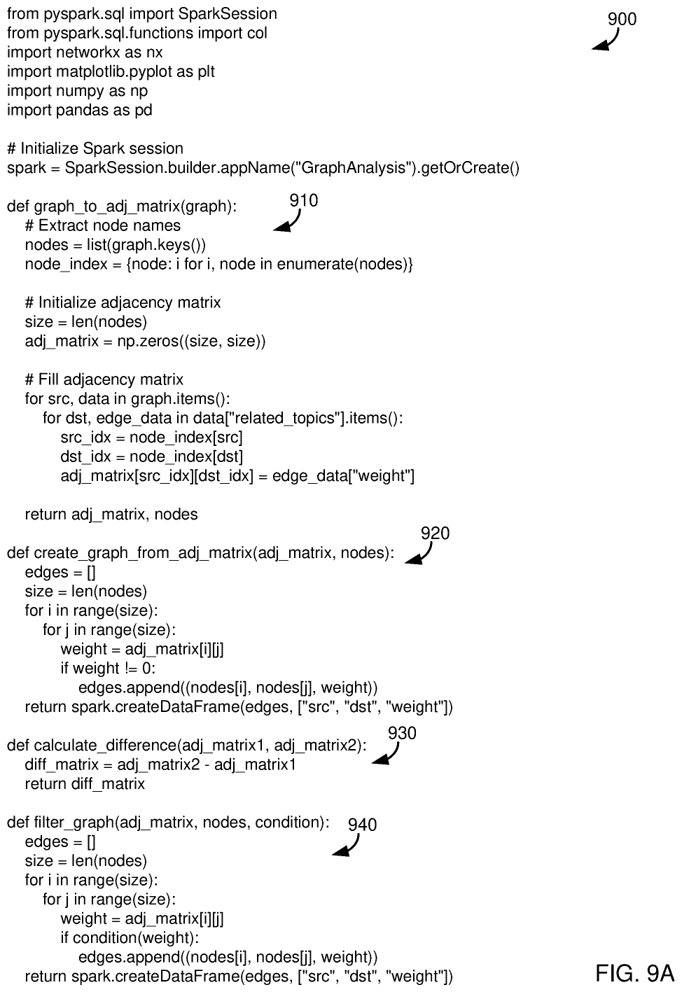

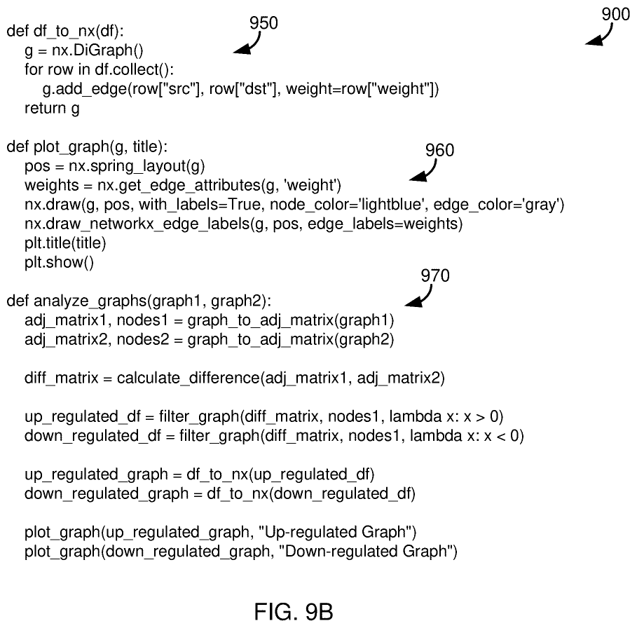

FIGS. 9A and 9B provide example Python code 900 that can be used to convert a graph, such as the one represented in FIG. 5, to an adjacency matrix, and then to perform operations to determine a difference graph, a graph of upregulated edges, and a graph of downregulated edges. The Python code uses the Spark distributed computing framework, which also facilitates parallelization of operations even on a single computing device.

With reference to FIG. 9A, code 910 provides a function to convert a graph, provided as an argument when the function is called, to an adjacency matrix. Along with creating an adjacency matrix, the function extracts node names from the graph, which can be used in correlating results of calculations using adjacency matrices with node names, such as for use in generating graph representations of such results. Code 920 provides a function to create a graph, represented as a DataFrame, from an adjacency matrix.

Code 930 calculates a difference between two adjacency matrices provided as arguments. Code 940 filters an adjacency matrix representation graph, such as a matrix corresponding to a difference graph, based on a condition provided as an argument. For example, the condition can be used to identify upregulated or downregulated edges.

Turning to FIG. 9B, code 950 converts a DataFrame, such as the one returned by code 920, to a NetworkX graph, which can be used to visualize graph results. Code 960 plots a graph using a NetworkX graph as an argument.

Code 970 orchestrates a process of generating and plotting graphs of upregulated and downregulated graphs using two input graphs.

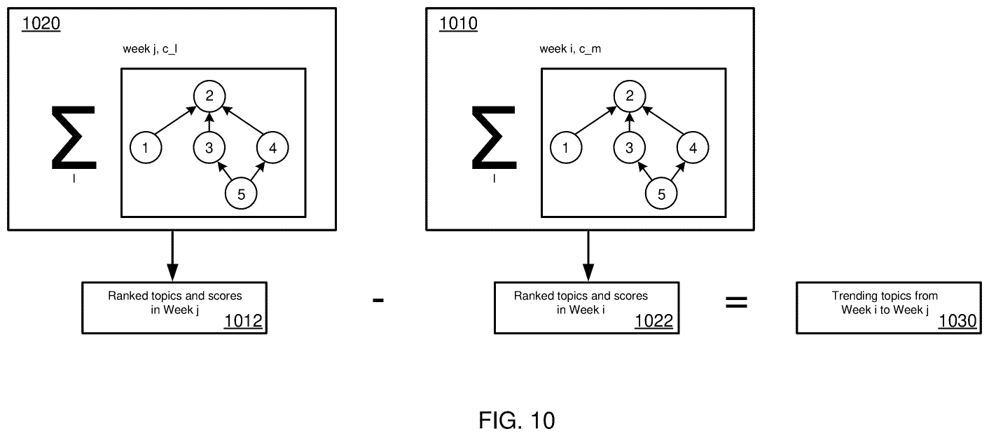

As illustrated in FIG. 10, another differential analysis can be performed by subtracting node intent scores of a graph 1010 at one time point from node intent scores of the graph 1020 at another time point. As with the graphs of FIG. 8, the graphs 1010, 1020 can represent combined intent data from multiple segments or multiple members of a particular segment. The graphs 1010, 1020 can be processed to extract relevant topics and their intent scores at particular points in time, such as the ranked topics and scores 1012, 1022, for the graphs 1010, 1020, respectively. Subtracting the intent scores provides information 1030 regarding trending topics over a particular time period, as opposed to trend information for topic relationships as in the other differential analysis. Nodes with higher scores indicate trending topics over a time period, as well as topics that are showing decreased user interest.

### Example 4—Example Force-Directed Graph Generation Process

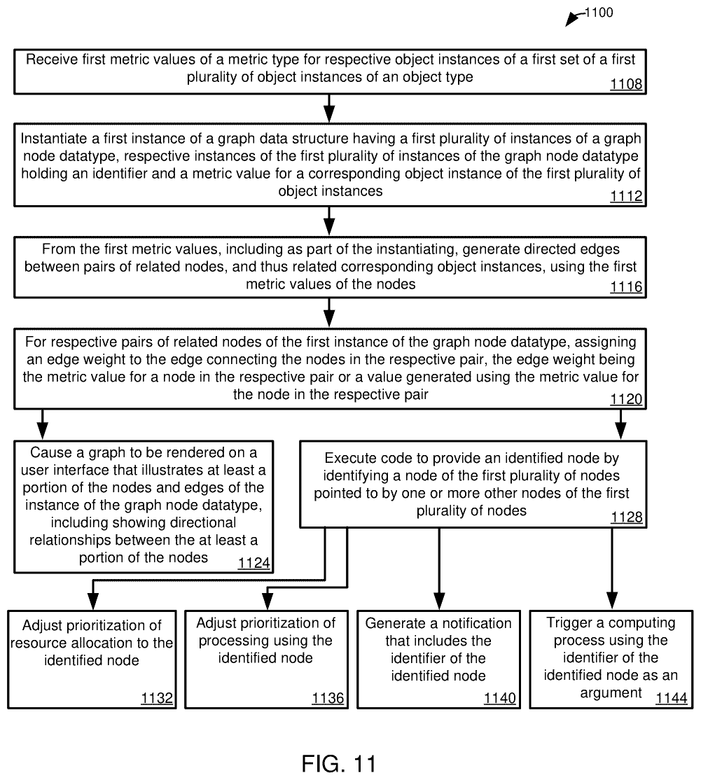

FIG. 11 is a flowchart of a process 1100 for generating a force-directed graph. At 1108, first metric values of a metric type for respective object instances of a first set of a first plurality of object instances of an object type are received. A first instance of a graph data structure having a first plurality of instances of a graph node datatype is instantiated at 1112. Respective instances of the first plurality of instances of the graph node datatype hold an identifier and a metric value for a corresponding object instance of the first plurality of object instances.

From the first metric values, including as part of the instantiating, directed edges between pairs of related nodes are generated at 1116, and thus related corresponding object instances, using the first metric values of the nodes. For respective pairs of related nodes of the first instance of the graph node datatype, the process 1100 assigns an edge weight to the edge connecting the nodes in the respective pair at 1120. The edge weight is the metric value for a node in the respective pair or a value generated using the metric value for the node in the respective pair.

In one scenario, at 1124, a graph to be rendered on a user interface that illustrates at least a portion of the nodes and edges of the instance of the graph node datatype, including showing directional relationships between the at least a portion of the node.

In another scenario, at 1128, code is executed to provide an identified node by identifying a node of the first plurality of nodes pointed to by one or more other nodes of the first plurality of nodes. The process 1100 adjusts prioritization of resource allocation to the identified node at 1132, generates a notification that includes the identifier of the identified node at 1136, generates a notification that includes the identifier of the identified node at 1140, or triggers a computing process using the identifier of the identified node as an argument at 1144.

### Example 5—Additional Examples

Example 1 provides a computing system that includes at least one memory, one or more hardware processor units coupled to the at least one memory, and one or more computer-readable storage media. The storage media contain computer-executable instructions that, when executed, cause the computing system to perform operations. These operations include receiving first metric values of a metric type for respective object instances of a first set of a first plurality of object instances of an object type.

A first instance of a graph data structure having a first plurality of instances of a graph node datatype is instantiated. Respective instances of the first plurality of instances of the graph node datatype hold an identifier and a metric value for a corresponding object instance of the first plurality of object instances.

From the first metric values, including as part of the instantiating, directed edges are generated between pairs of related nodes, and thus related corresponding object instances, using the first metric values of the nodes. For respective pairs of related nodes of the first instance of the graph node datatype, an edge weight is assigned to the edge connecting the nodes in the respective pair. The edge weight is the metric value for a node in the respective pair or a value generated using the metric value for the node in the respective pair.

In one scenario, the operations cause a graph to be rendered on a user interface that illustrates at least a portion of the nodes and edges of the instance of the graph node datatype, including showing directional relationships between the at least a portion of the nodes.

In another scenario, code is executed to provide an identified node by identifying a node of the first plurality of nodes pointed to by one or more other nodes of the first plurality of nodes. In this scenario various operations can further result, including adjusting prioritization of resource allocation to the identified node, adjusting prioritization of processing using the identified node, generating a notification comprising the identifier of the identified node, or triggering a computing process using the identifier of the identified node as an argument.

Example 2 is the computing system of Example 1, where generating directed edges comprises assigning a node in a pair of nodes having a lower metric value as an origination node and a node in the pair of nodes having a higher metric value as a termination node.

Example 3 is the computing system of Example 1 or Examiner 2, where assigning an edge weight uses a quotient of the metric values for nodes in a pair of nodes.

Example 4 is the computing system of Example 3, where nodes of the plurality of nodes having a higher metric value in a given pair of the nodes are identified as high-value nodes. Nodes of the first plurality of nodes having a lower metric value in a given pair of nodes are identified as low-value nodes. The assigning the edge weight includes normalizing the quotient using an aggregated value of metric value for low-value nodes or an aggregated metric value of high-value nodes.

Example 5 is the computing system of Example 3, where nodes of the plurality of nodes having a higher metric value in a given pair of the nodes are identified as high-value nodes. Assigning the edge weight includes normalizing the quotient using an aggregated value of metric value of high-value nodes.

Example 6 is the computing system of any of Examples 1-5. The operations further include receiving second metric values for the metric type for respective object instances of a second set of a second plurality of object instances of the object type. A second instance of the graph data structure is instantiated having a second plurality of instances of the graph node datatype. Respective instances of the second plurality of instances of the graph node datatype hold an identifier and a metric value for a corresponding object instance of the second plurality of object instances. At least a portion of the second plurality of instances correspond to object instances of the first plurality of object instances, but having a second metric value of the second metric values.

From the second metric values, including as part of the instantiating, directed edges are generated between pairs of related nodes, and thus related corresponding object instances, using the second metric values of the nodes. For respective pairs of related nodes of the second instance of the graph node datatype, an edge weight is assigned to the edge connecting the nodes in the respective pair. The edge weight is the metric value for a node in the respective pair or a value generated using the metric value for the node in the respective pair. A difference graph is generated by computing a difference in edge weights of the first graph instance and corresponding edge weights of the second graph instance.

Example 7 is the computing system of Example 6, further including generating a graph that only includes edges between nodes that have a positive difference.

Example 8 is the computing system of Example 6, further including generating a graph that only includes edges between nodes that have a negative difference.

Example 9 is the computing system of any of Examples 6-8, where the first metric values are metric values at a first point in time and the second metric values are metric values at a second point in time.

Example 10 is the computing system of any of Examples 6-9, further including generating a first adjacency matrix corresponding to the first instance of the graph data structure using the first metric values. A second adjacency matrix is generated corresponding to the second instance of the graph data structure using the second metric values. A difference between the first adjacency matrix and the second adjacency matrix is calculated.

Example 11 is the computing system of any of Examples 6-10, further including generating graph centrality metrics for nodes in the difference graph using edge weight differences. Alternatively, a stochastic process model is generated for nodes in the difference graph using edge weight differences.

Example 12 is the computing system of any of Examples 1-11, where the object type represents a topic and the first metric values represent user intent scores for instances of the topic generated from user interaction with electronic content associated with a corresponding topic.

Example 13 provides a method implemented in a computing system that includes at least one memory and one or more hardware processor units coupled to the at least one memory. The method includes receiving first metric values of a metric type for respective object instances of a first set of a first plurality of object instances of an object type. A first instance of a graph data structure is instantiated having a first plurality of instances of a graph node datatype. Respective instances of the first plurality of instances of the graph node datatype hold an identifier and a metric value for a corresponding object instance of the first plurality of object instances.

From the first metric values, including as part of the instantiating, directed edges between pairs of related nodes are generated, and thus related corresponding object instances, using the first metric values of the nodes. For respective pairs of related nodes of the first instance of the graph node datatype, an edge weight is assigned to the edge connecting the nodes in the respective pair. The edge weight is the metric value for a node in the respective pair or a value generated using the metric value for the node in the respective pair.

In one scenario, a graph is caused to be rendered on a user interface that illustrates at least a portion of the nodes and edges of the instance of the graph node datatype, including showing directional relationships between the at least a portion of the nodes.

In another scenarios, code is executed to provide an identified node by identifying a node of the first plurality of nodes pointed to by one or more other nodes of the first plurality of nodes. In this scenario, the method further includes one or more of prioritizing resource allocation to the identified node, adjusting prioritization of processing using the identified node, generating a notification including the identifier of the identified node, or triggering a computing process using the identifier of the identified node as an argument.

Example 14 is the method of Example 13, where generating directed edges includes assigning a node in a pair of nodes having a lower metric value as an origination node and a node in the pair of nodes having a higher metric value as a termination node.

Example 15 is the method of Example 13 or Example 14. The method further includes receiving second metric values for the metric type for respective object instances of a second set of a second plurality of object instances of the object type. A second instance of the graph data structure is generated having a second plurality of instances of the graph node datatype. Respective instances of the second plurality of instances of the graph node datatype hold an identifier and a metric value for a corresponding object instance of the second plurality of object instances. At least a portion of the second plurality of instances correspond to object instances of the first plurality of object instances, but having a second metric value of the second metric values.

From the second metric values, including as part of the instantiating, the directed edges are generated between pairs of related nodes, and thus related corresponding object instances, using the second metric values of the nodes. For respective pairs of related nodes of the second instance of the graph node datatype, an edge weight is assigned to the edge connecting the nodes in the respective pair. The edge weight is the metric value for a node in the respective pair or a value generated using the metric value for the node in the respective pair. A difference graph is generated by computing a difference in edge weights of the first graph instance and corresponding edge weights of the second graph instance.

Example 16 is the method of Example 15, where a graph is generated that only includes edges between nodes that have a positive difference or that only includes edges between nodes that have a negative difference.

Example 17 provides one or more non-transitory computer-readable storage media.

The storage media comprise computer-executable instructions that, when executed by a computing system that includes at least one memory and at least one hardware processor coupled to the at least one memory, cause the computing system to perform several operations.

These operations include receiving first metric values of a metric type for respective object instances of a first set of a first plurality of object instances of an object type. A first instance of a graph data structure having a first plurality of instances of a graph node datatype is instantiated. Respective instances of the first plurality of instances of the graph node datatype hold an identifier and a metric value for a corresponding object instance of the first plurality of object instances.

From the first metric values, including as part of the instantiating, directed edges are generated between pairs of related nodes, and thus related corresponding object instances, using the first metric values of the nodes. For respective pairs of related nodes of the first instance of the graph node datatype, an edge weight is assigned to the edge connecting the nodes in the respective pair. The edge weight is the metric value for a node in the respective pair or a value generated using the metric value for the node in the respective pair.

In one scenario, a graph is caused to be rendered on a user interface that illustrates at least a portion of the nodes and edges of the instance of the graph node datatype, including showing directional relationships between the at least a portion of the nodes.

In another scenario, code is executed to provide an identified node by identifying a node of the first plurality of nodes pointed to by one or more other nodes of the first plurality of nodes. This scenario further includes one or more of adjusting prioritization of resource allocation to the identified node, adjusting prioritization of processing using the identified node, generating a notification comprising the identifier of the identified node, or triggering a computing process using the identifier of the identified node as an argument.

Example 18 is the one or more computer-readable storage media of Example 17. The storage media further comprise computer-executable instructions that, when executed by the computing system, cause the computing system to receive second metric values for the metric type for respective object instances of a second set of a second plurality of object instances of the object type. A second instance of the graph data structure is instantiated having a second plurality of instances of the graph node datatype. Respective instances of the second plurality of instances of the graph node datatype hold an identifier and a metric value for a corresponding object instance of the second plurality of object instances. At least a portion of the second plurality of instances correspond to object instances of the first plurality of object instances, but having a second metric value of the second metric values.

From the second metric values, including as part of the instantiating, directed edges are generated between pairs of related nodes, and thus related corresponding object instances, using the second metric values of the nodes. For respective pairs of related nodes of the second instance of the graph node datatype, an edge weight is assigned to the edge connecting the nodes in the respective pair. The edge weight is the metric value for a node in the respective pair or a value generated using the metric value for the node in the respective pair. A difference graph is generated by computing a difference in edge weights of the first graph instance and corresponding edge weights of the second graph instance.

Example 19 is the one or more computer-readable storage media of Example 18. The storage media further comprise computer-executable instructions that, when executed by the computing system, cause the computing system to generate a graph that only includes edges between nodes that have a positive difference or that only includes edges between nodes that have a negative difference.

Example 20 is the one or more computer-readable storage media of any of Examples 17-19, where the computer-executable instructions that cause the computing system to generate directed edges comprise computer-executable instructions that cause the computing system to assign a node in a pair of nodes having a lower metric value as an origination node and a node in the pair of nodes having a higher metric value as a termination node.

### Example 6—Computing Systems

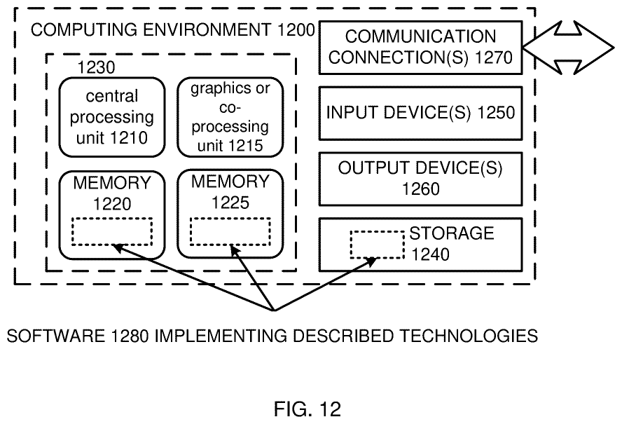

FIG. 12 depicts a generalized example of a suitable computing system 1200 in which the described innovations may be implemented. The computing system 1200 is not intended to suggest any limitation as to scope of use or functionality of the present disclosure, as the innovations may be implemented in diverse general-purpose or special-purpose computing systems.

With reference to FIG. 12, the computing system 1200 includes one or more processing units 1210, 1215 and memory 1220, 1225. In FIG. 12, this basic configuration 1230 is included within a dashed line. The processing units 1210, 1215 execute computer-executable instructions, such as for implementing a database environment, and associated methods, described in Examples 1-5. A processing unit can be a general-purpose central processing unit (CPU), a processor in an application-specific integrated circuit (ASIC), or any other type of processor. In a multi-processing system, multiple processing units execute computer-executable instructions to increase processing power. For example, FIG. 12 shows a central processing unit 1210 as well as a graphics processing unit or co-processing unit 1215. The tangible memory 1220, 1225 may be volatile memory (e.g., registers, cache, RAM), non-volatile memory (e.g., ROM, EEPROM, flash memory, etc.), or some combination of the two, accessible by the processing unit(s) 1210, 1215. The memory 1220, 1225 stores software 1280 implementing one or more innovations described herein, in the form of computer-executable instructions suitable for execution by the processing unit(s) 1210, 1215.

A computing system 1200 may have additional features. For example, the computing system 1200 includes storage 1240, one or more input devices 1250, one or more output devices 1260, and one or more communication connections 1270. An interconnection mechanism (not shown) such as a bus, controller, or network interconnects the components of the computing system 1200. Typically, operating system software (not shown) provides an operating environment for other software executing in the computing system 1200, and coordinates activities of the components of the computing system 1200.

The tangible storage 1240 may be removable or non-removable, and includes magnetic disks, magnetic tapes or cassettes, CD-ROMs, DVDs, or any other medium which can be used to store information in a non-transitory way, and which can be accessed within the computing system 1200. The storage 1240 stores instructions for the software 1280 implementing one or more innovations described herein.

The input device(s) 1250 may be a touch input device such as a keyboard, mouse, pen, or trackball, a voice input device, a scanning device, or another device that provides input to the computing system 1200. The output device(s) 1260 may be a display, printer, speaker, CD-writer, or another device that provides output from the computing system 1200.

The communication connection(s) 1270 enable communication over a communication medium to another computing entity, such as another database server. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules or components include routines, programs, libraries, objects, classes, components, data structures, etc. that perform particular tasks or implement particular abstract datatypes. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 7—Cloud Computing Environment

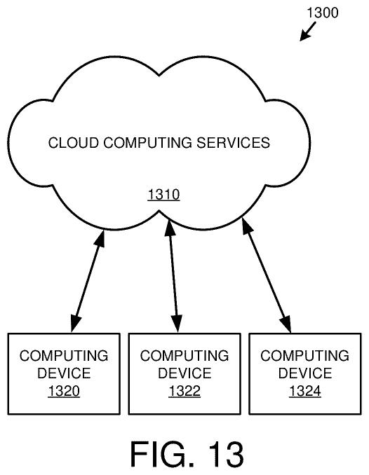

FIG. 13 depicts an example cloud computing environment 1300 in which the described technologies can be implemented. The cloud computing environment 1300 comprises cloud computing services 1310. The cloud computing services 1310 can comprise various types of cloud computing resources, such as computer servers, data storage repositories, networking resources, etc. The cloud computing services 1310 can be centrally located (e.g., provided by a data center of a business or organization) or distributed (e.g., provided by various computing resources located at different locations, such as different data centers and/or located in different cities or countries).

The cloud computing services 1310 are utilized by various types of computing devices (e.g., client computing devices), such as computing devices 1320, 1322, and 1324. For example, the computing devices (e.g., 1320, 1322, and 1324) can be computers (e.g., desktop or laptop computers), mobile devices (e.g., tablet computers or smart phones), or other types of computing devices. For example, the computing devices (e.g., 1320, 1322, and 1324) can utilize the cloud computing services 1310 to perform computing operators (e.g., data processing, data storage, and the like).

### Example 8—Implementations

Although the operations of some of the disclosed methods are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media, such as tangible, non-transitory computer-readable storage media, and executed on a computing device (e.g., any available computing device, including smart phones or other mobile devices that include computing hardware). Tangible computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 12, computer-readable storage media include memory 1220 and 1225, and storage 1240. The term computer-readable storage media does not include signals and carrier waves. In addition, the term computer-readable storage media does not include communication connections (e.g., 1270).

Any of the computer-executable instructions for implementing the disclosed techniques, as well as any data created and used during implementation of the disclosed embodiments, can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Python, Ruby, ABAP, Structured Query Language, Adobe Flash, or any other suitable programming language, or, in some examples, markup languages such as html or XML, or combinations of suitable programming languages and markup languages. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present, or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computing system comprising:
at least one memory;
one or more hardware processor units coupled to the at least one memory; and
one or more computer readable storage media storing computer-executable instructions that, when executed, cause the computing system to perform operations comprising:
receiving first metric values of a metric type for respective object instances of a first set of a first plurality of object instances of an object type;
instantiating a first instance of a graph data structure having a first plurality of instances of a graph node datatype, respective instances of the first plurality of instances of the graph node datatype holding an identifier and a metric value for a corresponding object instance of the first plurality of object instances;
from the first metric values, including as part of the instantiating, generating directed edges between pairs of related nodes, and thus related corresponding object instances, using the first metric values of the nodes;
for respective pairs of related nodes of the first instance of the graph node datatype, assigning an edge weight to the edge connecting the nodes in the respective pair, the edge weight being the metric value for a node in the respective pair or a value generated using the metric value for the node in the respective pair; and
(1) causing a graph to be rendered on a user interface that illustrates at least a portion of the nodes and edges of the instance of the graph node datatype, including showing directional relationships between the at least a portion of the nodes; or
(2) executing code to provide an identified node by identifying a node of the first plurality of nodes pointed to by one or more other nodes of the first plurality of nodes; and
adjusting prioritization of resource allocation to the identified node;
adjusting prioritization of processing using the identified node;
generating a notification comprising the identifier of the identified node; or
triggering a computing process using the identifier of the identified node as an argument.

2. The computing system of claim 1, wherein the generating directed edges comprises assigning a node in a pair of nodes having a lower metric value as an origination node and a node in the pair of nodes having a higher metric value as a termination node.

3. The computing system of claim 1, wherein the assigning an edge weight uses a quotient of the metric values for nodes in a pair of nodes.

4. The computing system of claim 3, wherein nodes of the plurality of nodes having a higher metric value in a given pair of the nodes are identified as high value nodes and nodes of the first plurality of nodes having a lower metric value in a given pair of nodes are identified as low value nodes, and the assigning the edge weight comprises normalizing the quotient using an aggregated value of metric value for low value nodes or an aggregated metric value of high value nodes.

5. The computing system of claim 3, wherein nodes of the plurality of nodes having a higher metric value in a given pair of the nodes are identified as high value nodes, and the assigning the edge weight comprises normalizing the quotient using an aggregated value of metric value of high value nodes.

6. The computing system of claim 1, the operations further comprising:
receiving second metric values for the metric type for respective object instances of a second set of a second plurality of object instances of the object type;
instantiating a second instance of the graph data structure having a second plurality of instances of the graph node datatype, respective instances of the second plurality of instances of the graph node datatype holding an identifier and a metric value for a corresponding object instance of the second plurality of object instances, at least a portion of the second plurality of instances corresponding to object instances of the first plurality of object instances, but having a second metric value of the second metric values;
from the second metric values, including as part of the instantiating, generating directed edges between pairs of related nodes, and thus related corresponding object instances, using the second metric values of the nodes;
for respective pairs of related nodes of the second instance of the graph node datatype, assigning an edge weight to the edge connecting the nodes in the respective pair, the edge weight being the metric value for a node in the respective pair or a value generated using the metric value for the node in the respective pair; and
generating a difference graph by computing a difference in edge weights of the first graph instance and corresponding edge weights of second graph instance.

7. The computing system of claim 6, the operations further comprising:
generating a graph that only comprises edges between nodes that have a positive difference.

8. The computing system of claim 6, the operations further comprising:
generating a graph that only comprises edges between nodes that have a negative difference.

9. The computing system of claim 6, wherein the first metric values are metric values at a first point in time and the second metric values are metric values at a second point in time.

10. The computing system of claim 6, the operations further comprising:
generating a first adjacency matrix corresponding to the first instance of the graph data structure using the first metric values;
generating a second adjacency matrix corresponding to the second instance of the graph data structure using the second metric values; and
calculating a difference between the first adjacency matrix and the second adjacency matrix.

11. The computing system of claim 6, the operation further comprising:
generating graph centrality metrics for nodes in the difference graph using edge weight differences; or
generating a stochastic process model for nodes in the difference graph using edge weight differences.

12. The computing system of claim 1, wherein the object type represents a topic and the first metric values represent user intent scores for instances of the topic generated from user interaction with electronic content associated with a corresponding topic.

13. A method, implemented in a computing system comprising at least one memory and one or more hardware processor units coupled to the at least one memory, the method comprising:
receiving first metric values of a metric type for respective object instances of a first set of a first plurality of object instances of an object type;
instantiating a first instance of a graph data structure having a first plurality of instances of a graph node datatype, respective instances of the first plurality of instances of the graph node datatype holding an identifier and a metric value for a corresponding object instance of the first plurality of object instances;
from the first metric values, including as part of the instantiating, generating directed edges between pairs of related nodes, and thus related corresponding object instances, using the first metric values of the nodes;
for respective pairs of related nodes of the first instance of the graph node datatype, assigning an edge weight to the edge connecting the nodes in the respective pair, the edge weight being the metric value for a node in the respective pair or a value generated using the metric value for the node in the respective pair; and
(1) causing a graph to be rendered on a user interface that illustrates at least a portion of the nodes and edges of the instance of the graph node datatype, including showing directional relationships between the at least a portion of the nodes; or
(2) executing code to provide an identified node by identifying a node of the first plurality of nodes pointed to by one or more other nodes of the first plurality of nodes; and
adjusting prioritization of resource allocation to the identified node;
adjusting prioritization of processing using the identified node;
generating a notification comprising the identifier of the identified node; or
triggering a computing process using the identifier of the identified node as an argument.

14. The method of claim 13, wherein the generating directed edges comprises assigning a node in a pair of nodes having a lower metric value as an origination node and a node in the pair of nodes having a higher metric value as a termination node.

15. The method of claim 13, the operations further comprising:
receiving second metric values for the metric type for respective object instances of a second set of a second plurality of object instances of the object type;
instantiating a second instance of the graph data structure having a second plurality of instances of the graph node datatype, respective instances of the second plurality of instances of the graph node datatype holding an identifier and a metric value for a corresponding object instance of the second plurality of object instances, at least a portion of the second plurality of instances corresponding to object instances of the first plurality of object instances, but having a second metric value of the second metric values;
from the second metric values, including as part of the instantiating, generating directed edges between pairs of related nodes, and thus related corresponding object instances, using the second metric values of the nodes;
for respective pairs of related nodes of the second instance of the graph node datatype, assigning an edge weight to the edge connecting the nodes in the respective pair, the edge weight being the metric value for a node in the respective pair or a value generated using the metric value for the node in the respective pair; and
generating a difference graph by computing a difference in edge weights of the first graph instance and corresponding edge weights of second graph instance.

16. The method of claim 15, the operations further comprising:
generating a graph that only comprises edges between nodes that have a positive difference or that only comprises edges between nodes that have a negative difference.

17. One or more non-transitory computer-readable storage media comprising:
computer-executable instructions that, when executed by a computing system comprising at least one memory and at least one hardware processor coupled to the at least one memory, cause the computing system to receive first metric values of a metric type for respective object instances of a first set of a first plurality of object instances of an object type;
computer-executable instructions that, when executed by the computing system, cause the computing system to instantiate a first instance of a graph data structure having a first plurality of instances of a graph node datatype, respective instances of the first plurality of instances of the graph node datatype holding an identifier and a metric value for a corresponding object instance of the first plurality of object instances;
computer-executable instructions that, when executed by the computing system, cause the computing system to, from the first metric values, including as part of the instantiating, generate directed edges between pairs of related nodes, and thus related corresponding object instances, using the first metric values of the nodes;
computer-executable instructions that, when executed by the computing system, cause the computing system to, for respective pairs of related nodes of the first instance of the graph node datatype, assign an edge weight to the edge connecting the nodes in the respective pair, the edge weight being the metric value for a node in the respective pair or a value generated using the metric value for the node in the respective pair; and
(1) computer-executable instructions that, when executed by the computing system, cause the computing system to cause a graph to be rendered on a user interface that illustrates at least a portion of the nodes and edges of the instance of the graph node datatype, including showing directional relationships between the at least a portion of the nodes; or
(2) computer-executable instructions that, when executed by the computing system, cause the computing system to execute code to provide an identified node by identifying a node of the first plurality of nodes pointed to by one or more other nodes of the first plurality of nodes; and
computer-executable instructions that, when executed by the computing system, cause the computing system to adjust prioritization of resource allocation to the identified node;
computer-executable instructions that, when executed by the computing system, cause the computing system to adjust prioritization of processing using the identified node;
computer-executable instructions that, when executed by the computing system, cause the computing system to generate a notification comprising the identifier of the identified node; or
computer-executable instructions that, when executed by the computing system, cause the computing system to trigger a computing process using the identifier of the identified node as an argument.

18. The one or more computer-readable storage media of claim 17, further comprising:
computer-executable instructions that, when executed by the computing system, cause the computing system to receive second metric values for the metric type for respective object instances of a second set of a second plurality of object instances of the object type;
computer-executable instructions that, when executed by the computing system, cause the computing system to instantiate a second instance of the graph data structure having a second plurality of instances of the graph node datatype, respective instances of the second plurality of instances of the graph node datatype holding an identifier and a metric value for a corresponding object instance of the second plurality of object instances, at least a portion of the second plurality of instances corresponding to object instances of the first plurality of object instances, but having a second metric value of the second metric values;
computer-executable instructions that, when executed by the computing system, cause the computing system to, from the second metric values, including as part of the instantiating, generate directed edges between pairs of related nodes, and thus related corresponding object instances, using the second metric values of the nodes;
computer-executable instructions that, when executed by the computing system, cause the computing system to, for respective pairs of related nodes of the second instance of the graph node datatype, assign an edge weight to the edge connecting the nodes in the respective pair, the edge weight being the metric value for a node in the respective pair or a value generated using the metric value for the node in the respective pair; and
computer-executable instructions that, when executed by the computing system, cause the computing system to generate a difference graph by computing a difference in edge weights of the first graph instance and corresponding edge weights of second graph instance.

19. The one or more computer-readable storage media of claim 18, further comprising:
computer-executable instructions that, when executed by the computing system, cause the computing system to generate a graph that only comprises edges between nodes that have a positive difference or that only comprises edges between nodes that have a negative difference.

20. The one or more computer-readable storage media of claim 17, wherein the computer-executable instructions that cause the computing system to generate directed edges compromise computer executable instructions that cause the computing system to assign a node in a pair of nodes having a lower metric value as an origination node and a node in the pair of nodes having a higher metric value as a termination node.
